(19) United States
(12) Patent Application Publication
(10) Pub. No.: US 2026/0086292 A1
(43) Pub. Date: Mar. 26, 2026

(54) Die-to-Wafer Reconstitution for Surface Relief Gratings

(71) Applicant: Apple Inc., Cupertino, CA (US)

(72) Inventors: Ping Qu, San Jose, CA (US); Bradley C. Steele, La Jolla, CA (US); Brandon Born, Sunnyvale, CA (US); Meng-Chien Lu, San Jose, CA (US); Jaein Choi, Sunnyvale, CA (US); Young Seok Kim, San Jose, CA (US); Hairong Tang, Los Gatos, CA (US); Shih Chang Chang, Cupertino, CA (US); Jani Tervo, Espoo (FI)

(21) Appl. No.: 19/277,972

(22) Filed: Jul. 23, 2025

Related U.S. Application Data
(60) Provisional application No. 63/697,084, filed on Sep. 20, 2024.

(51) Int. Cl. G02B 6/34; G02B 27/01

(52) U.S. Cl. CPC G02B 6/34; G02B 27/0172

(57) ABSTRACT

Passive optical devices and methods of assembly are described in which surface relief gratings are formed at wafer level for fine patterning and then transferred to an optically transparent layer as diced grating dies for final assembly and passive optical device singulation at either wafer level or panel level.

### RELATED APPLICATIONS

This application claims the benefit of priority of U.S. Provisional Application No. 63/697,084, filed Sep. 20, 2024, which is incorporated herein by reference.

### BACKGROUND

FIELD Embodiments described herein relate to surface relief gratings, and more particularly to passive optical devices including surface relief gratings.

### BACKGROUND INFORMATION

Augmented reality display systems commonly operate by projecting a virtual image to a user's eye while viewing real world images. One manner for achieving this is with optical waveguide technology where the virtual image can be injected into a waveguide from a source display, and then extracted in front of the eye where the image can be superimposed with the real-world vision. One attractive feature of such optical waveguide technology is the ability to provide a high field-of-view at low form factors.

### SUMMARY

Passive optical devices and methods of assembly are described. In an embodiment, a method of assembling a passive optical device includes bonding a first plurality of input coupler grating dies to an optically transparent substrate, bonding a second plurality of output coupler grating dies to the optically transparent substrate, encapsulating the first plurality of input coupler grating dies and the second plurality of output coupler grating dies in one or more gap fill layers to form a reconstituted substrate, and singulating a plurality of passive optical devices from the reconstituted substrate. The bonding sequence of the input coupler grating dies and output coupler grating dies can be in any sequence. In some embodiments, the output coupler grating dies are bonded to both sides of the optically transparent substrate. In accordance with embodiments the various grating dies can be fabricated at wafer level and diced prior to transfer to the optically transparent substrate.

In an embodiment, a passive optical device includes an optically transparent substrate, an input coupler grating die bonded to the optically transparent substrate, and an output coupler grating die bonded to the optically transparent substrate. A gap fill layer may additionally span between and over the input coupler grating die and the output coupler grating die. Each of the grating dies can include a fill media layer, a pattern in the fill media layer, and a corresponding grating material that fills the pattern in the fill media layer. Each grating die may also include a planar bottom surface spanning the fill media layer and grating material pattern, where the planar bottom surface is bonded to the optically transparent substrate.

### BRIEF DESCRIPTION OF THE DRAWINGS

FIG. 1 a schematic cross-sectional side view illustration of a display system in accordance with embodiments.

FIG. 2A is a schematic top view illustration of a donor wafer and close-up top view illustration of a first grating die in accordance with an embodiment.

FIG. 2B is a schematic close-up cross-sectional side view illustration of a first grating die of FIG. 2A in accordance with an embodiment.

FIG. 3A is a schematic top view illustration of a donor wafer and close-up top view illustration of a second grating die in accordance with an embodiment.

FIG. 3B is a schematic close-up cross-sectional side view illustration of a second grating die of FIG. 3A in accordance with an embodiment.

FIG. 4 is a schematic top view illustration of a reconstituted donor substrate in accordance with embodiments.

FIG. 5 is a schematic cross-sectional side view illustration of a passive optical device in accordance with an embodiment.

FIGS. 6A-6E are schematic cross-sectional side view illustrations of a sequence of forming an input coupler grating die in accordance with embodiments.

FIGS. 7A-7E are schematic top view illustrations of a sequence of forming an input coupler grating die donor wafer in accordance with embodiments.

FIGS. 8A-8E are schematic cross-sectional side view illustrations of a sequence of forming an output coupler grating die in accordance with embodiments.

FIGS. 9A-9E are schematic top view illustrations of a sequence of forming an output coupler grating die donor wafer in accordance with embodiments.

FIGS. 10A-10C are schematic cross-sectional side view illustrations for various grating die arrangements on an optically transparent substrate in accordance with embodiments.

FIGS. 11A-11H are schematic cross-sectional side view illustrations of a sequence of forming a passive optical device in accordance with embodiments.

FIG. 12 is a close-up schematic cross-sectional side view illustration of a grating die with a multi-layer fill media layer in accordance with an embodiment.

FIG. 13 is a close-up schematic cross-sectional side view illustration of a grating die with an interface layer in accordance with an embodiment.

FIG. 14 is a close-up schematic cross-sectional side view illustration of a grating with a metal or metallic fill media layer in accordance with an embodiment.

FIGS. 15A-15D are schematic cross-sectional side view illustrations for a sequence of forming a grating die with additive processing approach in accordance with embodiments.

### DETAILED DESCRIPTION

Embodiments describe passive optical devices and methods of fabrication. In particular, embodiments describe eye pieces that may be integrated into display systems such as augmented reality display systems, virtual reality display systems, etc.

In one aspect it has been observed that conventional eye piece fabrication techniques for augmented reality display systems can be limited by several factors that incur inefficient fabrication yield and cost. Foremost, the eye pieces can be large (e.g., greater than 40×40 mm²) compared to traditional chip sizes. While it may be more economical from an assembly cost to manufacture the eye pieces from glass panels this can be met with further inefficiencies. For example, the patterned features of the surface relief gratings (SRGs) can be relatively small (e.g., ˜100 nm to 400 nm) such that higher resolution patterning schemes are employed such as deep ultraviolet (DUV) lithography, or electron beam lithography for master synthesis when using nano-imprint lithography. Such patterning schemes can be implemented with wafer processes, however glass panel patterning resolutions are not yet mature. Nevertheless, it is also not so simple to simply pattern the SRG designs on glass wafers since the thickness of the glass eyepieces can change with different SRG designs. This can pose a challenge for glass wafer fabrication in semiconductor manufacturing equipment that is highly standardized and optimized for one wafer thickness.

In accordance with embodiments passive optical device, and in particular eye piece manufacturing techniques are described that can be both cost effective and highly flexible. The SRG patterns can be fabricated on standardized silicon wafers, which are then diced with traditional chip dicing techniques into discrete chips. The chips are then mounted onto high refractive index glass or polymer substrates (wafers or panels) using advanced packaging techniques. The silicon support layer can then be ground off with high precision, followed by deposition of an index matching encapsulation material, also referred to as a gap fill layer, onto the high refractive index glass substrate, optional polishing of the reconstituted substrate, and eye piece singulation from the reconstituted substrate.

The passive optical device manufacturing techniques in accordance with embodiments can provide high SRG pattern yield per fabricated wafer since the silicon wafers are dedicated for SRG patterns. This can improve assembly time and cost compared to patterning the SRG patterns onto optically transparent wafers or panels (e.g., glass, polymer) supporting underlying eye pieces, where the SRG pattern area can be low. The die-to-wafer reconstitution sequences also separate SRG patterns from the eye piece shape, and thickness of the high refractive index glass, or even high refractive index polymer substrate. This allows for total thickness variation control that could potentially otherwise cause difficulties with more traditional photolithographic processes or nano-imprint processes.

The passive optical device (e.g., eye piece) manufacturing techniques in accordance with embodiments can also separate process flows at different zones of the eye pieces, allowing more flexibility in the design space such as with including different SRG materials, shape, size, and height. The chip-on-wafer (CoW), also referred to as die-to-wafer, bonding techniques can be used to add a custom interface to the input coupler or output coupler regions to enhance performance, and can be used to assemble single sided or dual sided passive optical devices (e.g., eye pieces) at the same time.

In various embodiments, description is made with reference to figures. However, certain embodiments may be practiced without one or more of these specific details, or in combination with other known methods and configurations. In the following description, numerous specific details are set forth, such as specific configurations, dimensions and processes, etc., in order to provide a thorough understanding of the embodiments. In other instances, well-known semiconductor processes and manufacturing techniques have not been described in particular detail in order to not unnecessarily obscure the embodiments. Reference throughout this specification to “one embodiment” means that a particular feature, structure, configuration, or characteristic described in connection with the embodiment is included in at least one embodiment. Thus, the appearances of the phrase “in one embodiment” in various places throughout this specification are not necessarily referring to the same embodiment. Furthermore, the particular features, structures, configurations, or characteristics may be combined in any suitable manner in one or more embodiments.

The terms “over”, “to”, “between”, “spanning” and “on” as used herein may refer to a relative position of one layer with respect to other layers. One layer “over”, “spanning” or “on” another layer or bonded “to” or in “contact” with another layer may be directly in contact with the other layer or may have one or more intervening layers. One layer “between” layers may be directly in contact with the layers or may have one or more intervening layers.

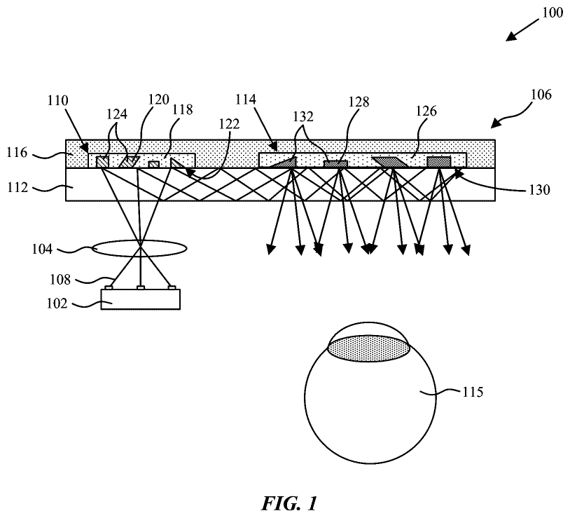

Referring now to FIG. 1, a schematic cross-sectional side view illustration is provided of a display system 100 including a source display 102, lens 104 and passive optical device 106. In operation, light 108 (i.e., image) is emitted from the source display 102, focused through lens 104 to the passive optical device 106 where the light is diffracted at input coupler grating die 110 through an optically transparent substrate 112, and diffracted at an output coupler grating die 114 where the light (or image) is extracted for viewing by a user 115. The optically transparent substrate 112 in accordance with embodiments is in effect a waveguide where the source display image is transmitted by total internal reflection, and either input or extracted at the corresponding grating dies. The optically transparent substrate 112 may be formed of a suitable high index glass or polymer for example. The input coupler grating die 110 and output coupler grating die 114 can be bonded to the optically transparent substrate 112 with advanced packaging techniques, such as chip-on-wafer (CoW) fusion bonding. Various pre-bonding treatment processes may also be performed prior to the CoW transfer operations to facilitate bonding. It is to be appreciated that display system 100 illustrated in FIG. 1 is exemplary and embodiments are not limited to this configuration. For example, the external light source can be from either side of the optically transparent substrate 112. Furthermore, pluralities of the input coupler grating dies 100 and/or output coupler grating dies 114 can be included on either side of the optically transparent substrate 112. Additional components can also be included such as cross-couplers, secondary input couplers, performance enhancement films, etc. While embodiments are described and illustrated with specific regard to an eye piece, the various die-to-wafer reconstitution assembly techniques described herein can also be applied to other passive optical devices such as light intensity sensors, etc. Furthermore, a variety of coupling techniques can be incorporated. For example, the in-coupling can be diffractive or reflective as illustrated, and may also be transmissive.

The input coupler grating die 110 and output coupler grating die 114 in accordance with embodiments can be pre-fabricated at the wafer level and diced using a suitable technique such as blade sawing (cutting), plasma dicing, etc. This enables a high density of grating dies to be fabricated at the wafer level before being diced and transferred to the optically transparent substrate 112, which can be a wafer or panel substrate prior to singulation of the passive optical devices.

In an embodiment, a passive optical device 106 includes an optically transparent substrate 112, an input coupler grating die 110 bonded to the optically transparent substrate 112, and an output coupler grating die 114 bonded to the optically transparent substrate 112. As shown, a gap fill layer 116 can span between the input coupler grating die 110 and the output coupler grating die 114, and also span over the input coupler grating die 110 and the output coupler grating die 114. As such, the gap fill layer 116 may encapsulate the input coupler grating die 110 and the output coupler grating die 114 on the optically transparent substrate 112. Additionally, the gap fill layer 116 can be deposited directly onto the optically transparent substrate 112 not covered by other components such as grating dies. In accordance with embodiments, the input coupler grating die 110 can includes a first fill media layer 118, a first pattern in the first fill media layer, and a first grating material pattern 120 filling the first pattern in the first fill media layer such that the first grating material pattern 120 is embedded in the first fill media layer 118. As will become apparent in the following description, this can be achieved by first patterning one or more layers of the first fill media layer 118 and depositing the first grating material over and into the patterned first fill media layer. Alternatively, one or more layers of the first grating material can be patterned followed by depositing the first fill media layer to embed the first grating material pattern in the first fill media layer. The input coupler grating die 110 can additionally include a first planar bottom surface 122 spanning the first fill media layer 118 and the first grating material pattern 120, where the first planar bottom surface is bonded to the optically transparent substrate 112. As will become apparent in the following description, formation of the first planar bottom surface 122 may also create a plurality of discrete fins 124 in the first grating material pattern 120 that may be physically isolated from one another. The fill media layers and grating material patterns in accordance with embodiments can be single layers or multi-layer structures to provide more complex shapes. The various multiple players can also be formed of the same or different materials.

In accordance with embodiments the optically transparent substrate 112, first fill media layer 118 and first grating material pattern 120 can be characterized by refractive index relative to one another. For example, optically transparent substrate 112 and first grating material pattern 120 may each be characterized by a refractive index that is higher than that of the first fill media layer 118. Suitable materials may be selected based upon particular application. For example, the optically transparent substrate 112 may be formed of a suitable high refractive index glass or polymer material. The first grating material pattern 120 may be formed of a suitable material such as an oxide (e.g., silicon dioxide, titanium dioxide), oxynitride (e.g., silicon oxynitride), or other suitable inorganic material or polymer. The first fill media layer 118 may be formed of similar lower refractive index materials including oxides (e.g., silicon dioxide), oxynitride (e.g., silicon oxynitride), or other suitable inorganic material or polymer. The gap fill layer 116 may further be formed of similar, or the same material, as the first fill media layer 118. Where the gap fill layer 116 and the first fill media layer 118 are formed of the same material, this may be physically detectable as well as chemically detectable with a higher oxygen concentration at the boundaries of the first fill media layer 118 due to additional exposure to environment and processing. In an exemplary embodiment the first fill media layer(s) 118 and gap fill layer 116 are formed of silicon dioxide, and the first grating material pattern 120 is formed of titanium dioxide, though embodiments are not limited to this combination of materials. In some embodiments the first fill media layer 118 is formed of a metal such as, but not limited to, aluminum or silver and the gap fill layer 116 is formed of a non-metallic material (e.g., silicon dioxide). As will become apparent in the following description, a metal first fill media layer 118 may be formed utilizing a different process sequence than a dielectric first fill media layer 118.

The output coupler grating die 114 may be integrated similarly as the input coupler grating die 110. For example, the output coupler grating die 114 can include a second fill media layer 126, a second grating material pattern 128 filling a second pattern in the second fill media layer such that the second grating material pattern 128 is embedded in the second fill media layer 126, and a second planar bottom surface 130 spanning the second fill media layer 126 and the second grating material pattern 128, where the second planar bottom surface 130 is bonded to the optically transparent substrate 112. As will become apparent in the following description, formation of the second planar bottom surface 130 may also create a plurality of discrete fins 132 in the second grating material pattern 128 that may be physically isolated from one another.

The input coupler grating dies 110 and output coupler grating dies 114 in accordance with embodiments are not limited to being formed of dielectric materials. For example, metal can be used to help define the discrete fins formed of a dielectric material. However, transparent dielectric materials may be selected as opposed to metals or metallic materials where transparency is needed, such as output coupler grating dies for augmented reality eye pieces. Additionally, the formation of the discrete fins may be a multi-layer process. For example, the fill media layers may be formed of multiple layers to define patterns within which to form the discrete fins. Alternatively, multiple grating material layers may be used to form the grating material patterns prior to forming a bulk fill media layer.

The CoW assembly techniques in accordance with embodiments can also allow for decoupling of the various grating dies assembled on the optically transparent substrate. For example, the first grating material pattern 120 and second grating material pattern 128 can be formed using different facility processes with different dimensions and different maximum heights. Chip-on-wafer processing can also be integrated with single-sided and double-sided assembly with the grating dies, allowing for a variety of configurations for input coupler grating dies and output coupler grating dies on one or both sides of the optically transparent substrate. The CoW bonding techniques can be used to add a custom interface to the input coupler or output coupler regions to enhance performance.

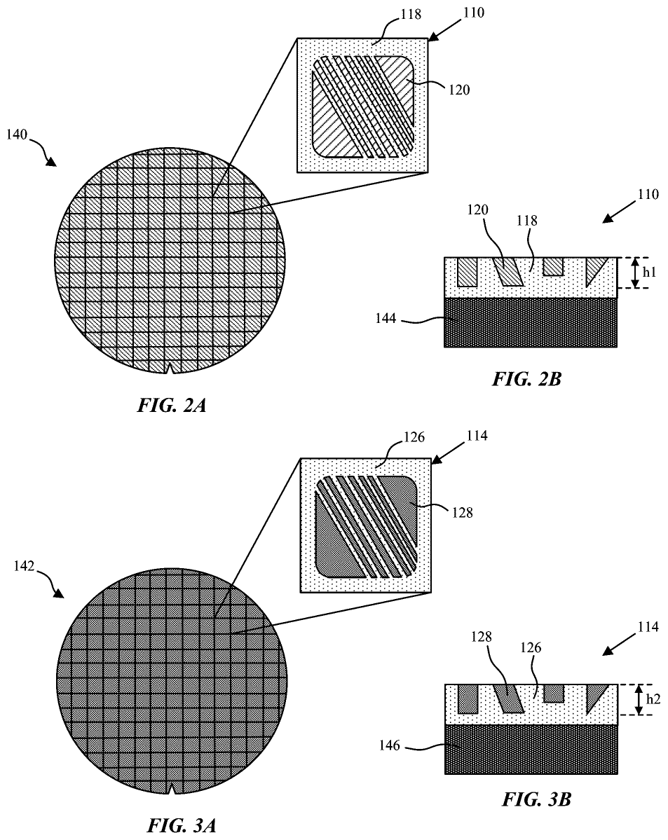

Referring now to FIGS. 2A-2B, FIG. 2A is a schematic top view illustration of an input coupler grating die donor wafer 140 and close-up top view illustration of an input coupler grating die in accordance with an embodiment; FIG. 2B is a schematic close-up cross-sectional side view illustration of an input coupler grating die of FIG. 2A in accordance with an embodiment. As shown, the input coupler grating die donor wafer 140 may include a first base wafer 144, such as a silicon wafer or glass wafer, which has been processed to include an array of input coupler grating dies 110, each including a first grating material pattern 120 embedded in a first fill media layer 118 and planarized to form first planar bottom surface 122. As shown, the first grating material pattern 120 has a first maximum height (h1).

Referring to FIGS. 3A-3B, FIG. 3A is a schematic top view illustration of an output coupler grating die donor wafer 142 and close-up top view illustration of an output coupler grating die in accordance with an embodiment; FIG. 3B is a schematic close-up cross-sectional side view illustration of an output coupler grating die of FIG. 3A in accordance with an embodiment. As shown, the output coupler grating die donor wafer 142 may include a first base wafer 146, such as a silicon wafer or glass wafer, which has been processed to include an array of output coupler grating dies 114, each including a second grating material pattern 128 embedded in a second fill media layer 126 and planarized to form second planar bottom surface 130. As shown, the second grating material pattern 128 has a second maximum height (h2), and may have different dimensions than the first grating material pattern.

It is to be appreciated that each of the input coupler grating die donor wafer 140 and output coupler grating die donor wafer 142 can be manufactured at wafer-scale, using suitable higher resolution patterning schemes such as deep ultraviolet (DUV) lithography, or electron beam lithography for master synthesis to achieve pattern features of the SRG that are relatively small (e.g., ˜100 nm to 400 nm). Upon dicing, the pluralities of grating dies from one or more donor wafers can then be transferred to an optically transparent substrate 112 using CoW transfer techniques.

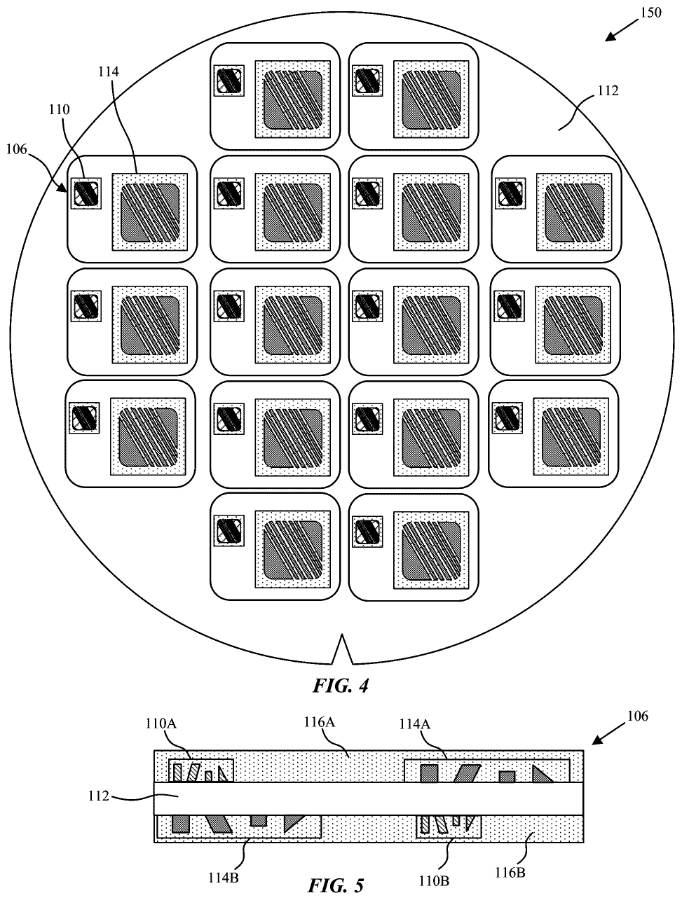

Referring now to FIGS. 4-5, FIG. 4 is a schematic top view illustration of a reconstituted donor substrate 150 in accordance with embodiments; FIG. 5 is a schematic cross-sectional side view illustration of a passive optical device 106 that can be singulated from the reconstituted donor substrate 150 of FIG. 4. As shown in FIGS. 4-5 once diced, pluralities of the input coupler grating dies 110A, 110B and output coupler grating dies 114A, 114B can be transferred to one or both sides of an optically transparent substrate 112, which can be either a wafer or panel for example, followed by additional processing such as application of gap fill layers 116A, 116B, planarization, and singulation of the passive optical devices 106 from the reconstituted donor substrate 150. For example, singulation may include cutting through one or more gap fill layers and the optically transparent substrate. A variety of additional components can also be included such as cross-couplers, secondary input couplers, performance enhancement films, etc.

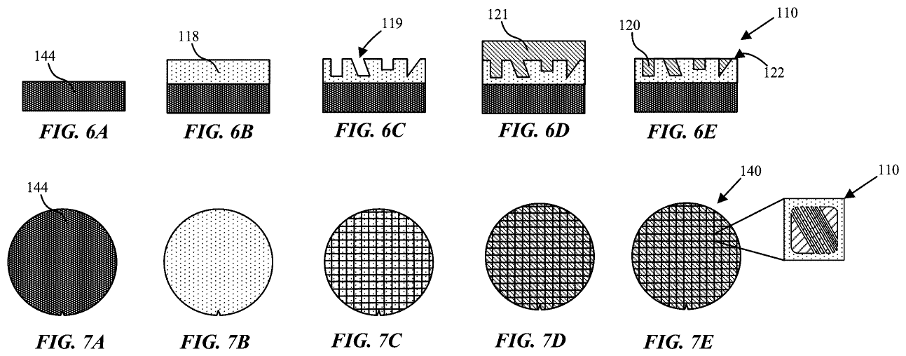

The process of forming the input coupler grating dies 110 may begin with a wafer, such as silicon wafer or glass wafer. Referring to FIGS. 6A-6E and FIGS. 7A-7E, FIGS. 6A-6E are schematic cross-sectional side view illustrations of a sequence of forming an input coupler grating die 110 in accordance with embodiments; FIGS. 7A-7E are schematic top view illustrations of a sequence of forming an input coupler grating die donor wafer 140 from which arrays of input coupler grating dies 110 are diced in accordance with embodiments. As shown in FIG. 6A and FIG. 7A, the fabrication sequence can begin with a first base wafer 144, such as a silicon or glass wafer. A first fill media layer 118 can then be deposited as shown in FIG. 6B and FIG. 7B using a suitable technique such as physical vapor deposition (PVD), chemical vapor deposition (CVD), or spin coating depending on the material selection. Suitable materials may be lower refractive index materials including oxides (e.g., silicon dioxide), oxynitride (e.g., silicon oxynitride), or other suitable inorganic material or polymer. An array of first patterns 119 are then formed in the first fill media layer 118 as shown in FIG. 6C and FIG. 7C. Higher resolution patterning schemes available for wafer-level processing can be employed such as deep ultraviolet (DUV) lithography. In an alternate process flow electron beam lithography may be used for master synthesis. A first grating material 121 can then be deposited over the first fill media layer 118 and within the first patterns 119 as shown in FIG. 6D and FIG. 7D. While a single first fill media layer 118 is illustrated, it is to be appreciated that the first fill media layer 118 may be formed of multiple layers to form more complex first patterns 119.

The first grating material 121 may be deposited using a suitable technique such as physical vapor deposition (PVD), chemical vapor deposition (CVD), or spin coating depending on the material selection. The first grating material 121 may be formed of a suitable material such as an oxide (e.g., silicon dioxide, titanium dioxide), oxynitride (e.g., silicon oxynitride), or other suitable inorganic material or polymer, and may be a higher index material than the first fill media layer 118 material. If necessary, additional first fill media layer 118 material may then optionally be deposited. A polishing operation may then be performed on the first grating material 121 to expose the first fill media layer 118, resulting in a first grating material pattern 120 that fills the first pattern 119 in the first fill media layer 118, and a planarized bottom surface 122 as shown in FIG. 6E and FIG. 7E. This may be followed by dicing of the array of input coupler grating dies 110 from the input coupler grating die donor wafer 140.

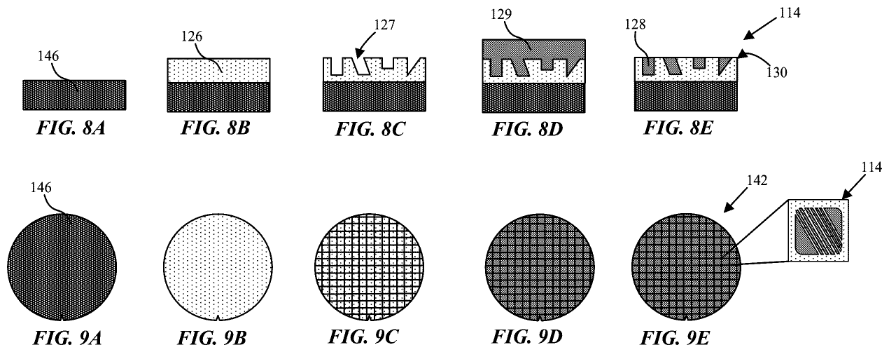

The process of forming the output coupler grating dies 114 may be substantially similar. Referring to FIGS. 8A-8E and FIGS. 9A-9E, FIGS. 8A-8E are schematic cross-sectional side view illustrations of a sequence of forming an output coupler grating die 114 in accordance with embodiments; FIGS. 9A-9E are schematic top side view illustrations of a sequence of forming an output coupler grating die donor wafer 142 from which arrays of output coupler grating dies 114 are diced in accordance with embodiments. As shown in FIG. 8A and FIG. 9A, the fabrication sequence can begin with a second base wafer 146, such as a silicon or glass wafer. A second fill media layer 126 can then be deposited as shown in FIG. 8B and FIG. 9B using a suitable technique such as physical vapor deposition (PVD), chemical vapor deposition (CVD), or spin coating depending on the material selection. Suitable materials may be lower refractive index materials including oxides (e.g., silicon dioxide), oxynitride (e.g., silicon oxynitride), or other suitable inorganic material or polymer. An array of second patterns 127 are then formed in the second fill media layer 126 as shown in FIG. 8C and FIG. 9C. Higher resolution patterning schemes available for wafer-level processing can be employed such as deep ultraviolet (DUV) lithography. In an alternate process flow electron beam lithography may be used for master synthesis. A second grating material 129 can then be deposited over the second fill media layer 126 and within the second patterns 127 as shown in FIG. 8D and FIG. 9D. While a single second fill media layer 126 is illustrated, it is to be appreciated that the second fill media layer 126 may be formed of multiple layers to form more complex first patterns 127.

The second grating material 129 may be deposited using a suitable technique such as physical vapor deposition (PVD), chemical vapor deposition (CVD), or spin coating depending on the material selection. The second grating material 129 may be formed of a suitable material such as an oxide (e.g., silicon dioxide, titanium dioxide), oxynitride (e.g., silicon oxynitride), or other suitable inorganic material or polymer, and may be a higher index material than the second fill media layer 126 material. If necessary, additional second fill media layer 126 material may then optionally be deposited. A polishing operation may then be performed on the second grating material 129 to expose the second fill media layer 126, resulting in a second grating material pattern 128 that fills the second pattern 127 in the second fill media layer 126, and a planarized bottom surface 130 as shown in FIG. 8E and FIG. 9E. This may be followed by dicing of the array of output coupler grating dies 114 from the output coupler grating die donor wafer 142.

Following dicing of the grating dies from the donor substrates the grating dies can be bonded to an optically transparent substrate using suitable pick and place techniques and CoW bonding. Specifically, the planarized bottom surfaces of the grating dies can be bonded to optically transparent substrates with or without surface treatment, such as plasma processes or growth of thin oxide layers to facilitate fusion bonding under heat and pressure.

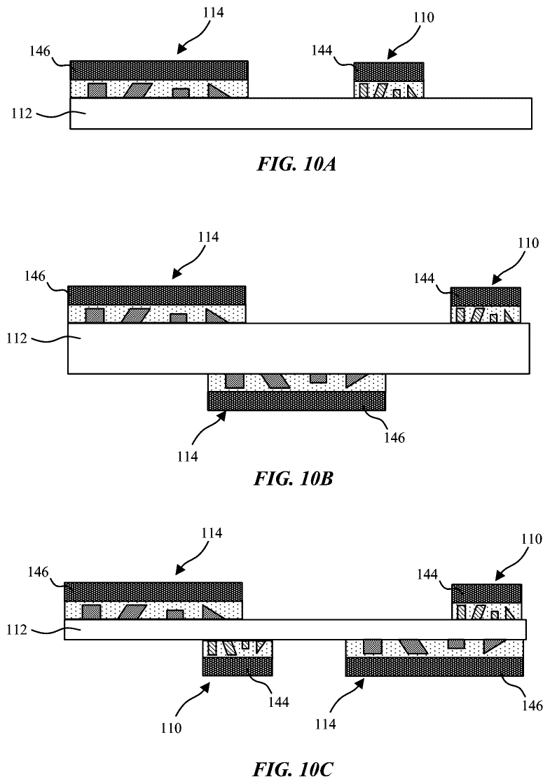

FIGS. 10A-10C are schematic cross-sectional side view illustrations for various grating die arrangements on an optically transparent substrate in accordance with embodiments. In the exemplary arrangement shown in FIG. 10A one or more input coupler grating dies 110 and one or more output coupler grating dies 114 are bonded to the same side of an optically transparent substrate 112. Bonding may be accomplished using suitable techniques such as fusion bonding with dielectric-dielectric bonds, plasma-enhanced fusion bonding or adhesive bonding with an interfacial adhesive layer (e.g., polymer) that may optionally be cured during bonding. As shown, at this stage the diced base wafers 144, 146 may still be attached. One or more grating dies can also be bonded to opposite sides of the optically transparent substrate 112 as shown in FIGS. 10B-10C. It is to be appreciated that the order of bonding specific dies or sides can be varied as the situation requires. Furthermore, the optically transparent substrate 112 can have a variable thickness as shown in FIGS. 10B-10C, and is not limited to conventional wafer thicknesses since the fine patterning operations are performed on the donor substrates.

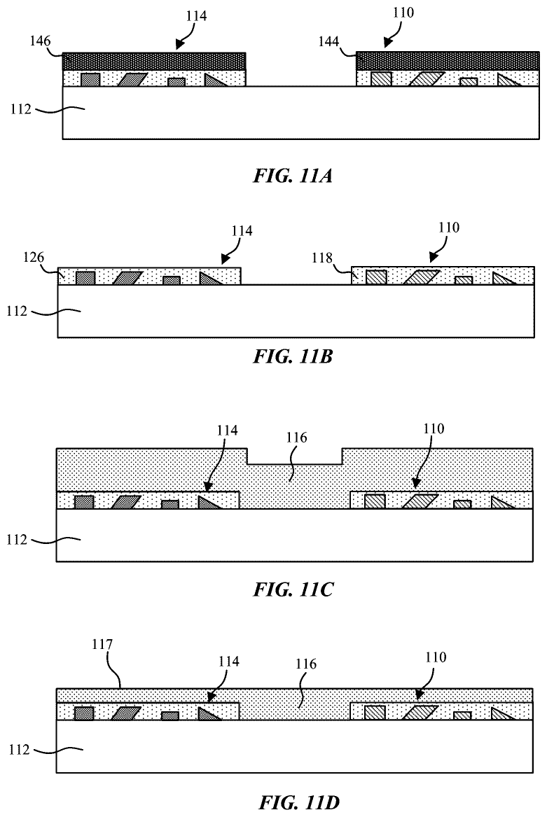

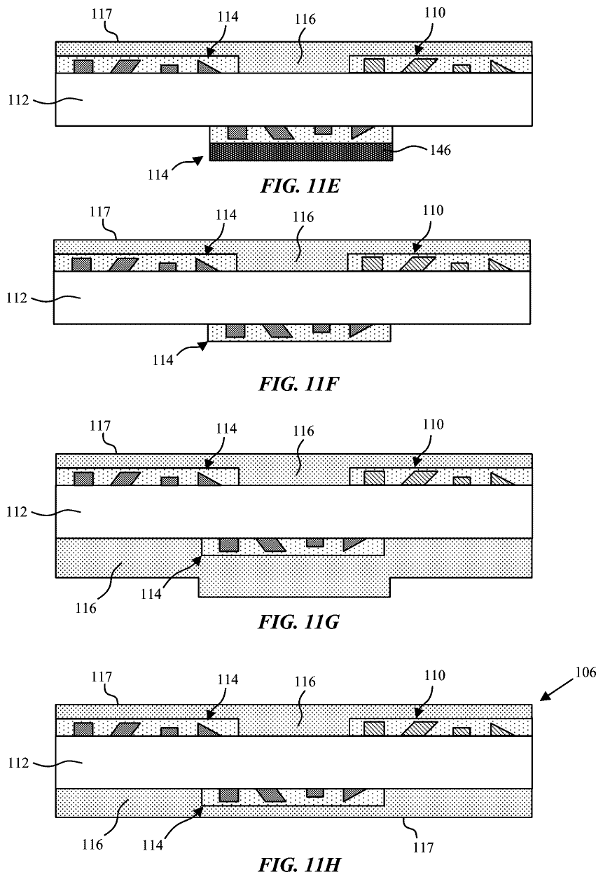

FIGS. 11A-11G are schematic cross-sectional side view illustrations of a sequence of forming a passive optical device 106 in accordance with embodiments. It is to be appreciated that the illustrations in FIGS. 11A-11G are close-up views for a single passive optical device that is fabricated at the wafer-level or panel-level prior to singulation. As shown in FIG. 11A, one or more one or more input coupler grating dies 110 and one or more output coupler grating dies 114 are bonded to a same side of an optically transparent substrate 112. Bonding may be accomplished using suitable techniques such as fusion bonding with dielectric-dielectric bonds, plasma-enhanced fusion bonding or adhesive bonding with an interfacial adhesive layer (e.g., polymer) that may optionally be cured during bonding. This can be followed by a grinding operation to remove the diced base wafers 144, 146 from the back sides of the grating dies as shown in FIG. 11B. A gap fill layer 116 can then be applied over optically transparent substrate and the one or more one or more input coupler grating dies 110 and one or more output coupler grating dies 114 to encapsulate the one or more one or more input coupler grating dies 110 and one or more output coupler grating dies 114 as shown in FIG. 11C. This may then be followed by a polishing operation as shown in FIG. 11D to provide a smooth surface 117. The process sequences can also be varied as the situation requires. For example, the gap fill layer 116 can be applied prior to removal of the diced base wafers 144, 146 from the back sides of the grating dies.

In accordance with embodiment the gap fill layer 116 may be formed of the same material as the first fill media layer 118 and/or the first fill media layer 126. In accordance with embodiments, the surface of the first fill media layer 118 and/or the first fill media layer 126 may be detected by a higher oxygen concentration. This may be due to exposure to ambient atmosphere, as well as previous upstream processing such as dicing.

The process may then be repeated for the opposite side of the optically transparent substrate 112. As shown in FIG. 11E, one or more one or more input coupler grating dies 110 and/or one or more output coupler grating dies 114 are bonded to the opposite side of the optically transparent substrate 112. This can be followed by a grinding operation to remove the diced base wafers 144, 146 from the back sides of the grating dies as shown in FIG. 11F. A gap fill layer 116 can then be applied over optically transparent substrate and the one or more one or more input coupler grating dies 110 and/or one or more output coupler grating dies 114 to encapsulate the one or more one or more input coupler grating dies 110 and/or one or more output coupler grating dies 114 as shown in FIG. 11G. This may then be followed by a polishing operation as shown in FIG. 11H to provide a smooth surface 117. The process sequences can also be varied as the situation requires. For example, the gap fill layer 116 can be applied prior to removal of the diced base wafers 144, 146 from the back sides of the grating dies.

In an alternate process flows the one or more grating dies can be applied to both of the opposite sides of the optically transparent substrate, followed by grinding, formation of both gap fill layers, etc.

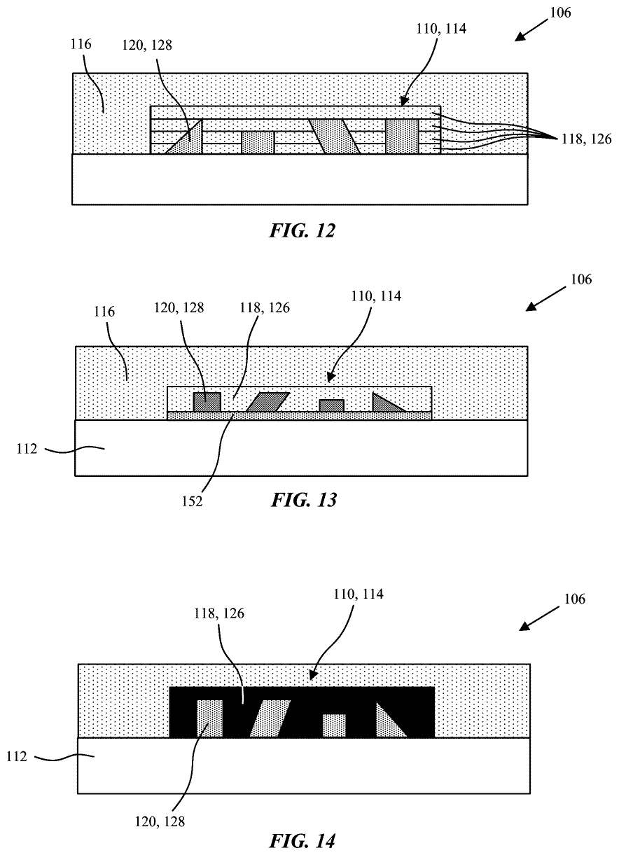

Up until this point the various illustrations of embodiments have generically shown the gap fill layers and grating material patterns as single layers. It is to be appreciated that multi-layer processes can be performed to generate the gap fill layers and/or the grating material patterns. FIG. 12 is a close-up schematic cross-sectional side view illustration of a grating die 110, 114 with a multi-layer fill media layer 118, 126 in accordance with an embodiment. Referring briefly back to FIGS. 6C-6E and FIGS. 8C-8E, formation of the patterns 119, 127 can be a multi-layer process, followed by deposition of a single layer of grating material 121, 129 for example, though multiple layers of grating material 121, 129 can also be deposited.

In accordance with embodiments, the CoW bonding techniques can be used to add a custom interface to the input coupler or output coupler regions to enhance performance. Referring briefly to FIG. 6E and FIG. 8E, prior to dicing, an interface layer can optionally be deposited. Alternatively, an interface layer can be formed on the dies after dicing. FIG. 13 is a close-up schematic cross-sectional side view illustration of a grating die 110, 114 with an interface layer 152 in accordance with an embodiment. For example, the interface layer 152 can be a high refractive index material as described herein, and may be bonded to the optically transparent substrate 112. In an embodiment, the interface layer 152 (e.g., titanium dioxide, silicon carbide) can be deposited on the planar bottom surface 122, 130 using a suitable technique such as low pressure chemical vapor deposition, sputtering, or spin-coating. The interface layer 152 in turn is bonded (e.g., directly to) the optically transparent substrate 112. For example, when included as part of the input coupler grating die 110 the interface layer 152 may improve efficiency and aid in efficiency of reflection of the input coupler grating die 110.

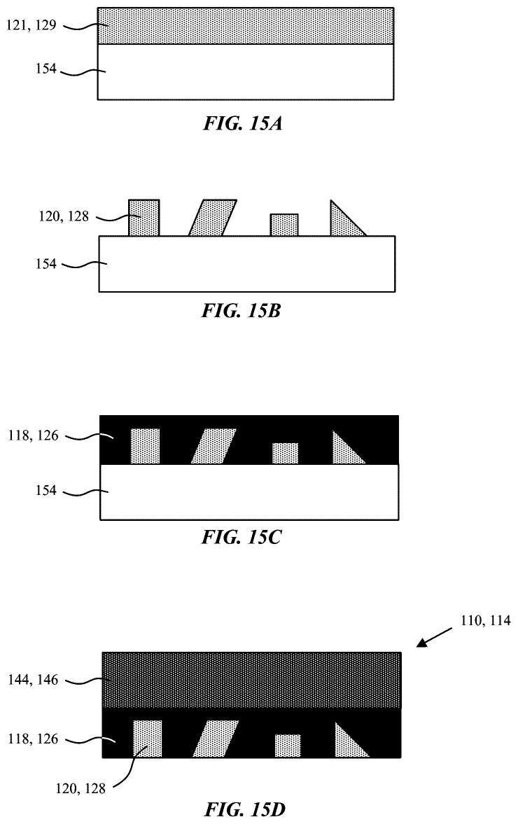

While both of the gap fill layers and the grating material patterns can be formed of dielectric or insulating materials, embodiments are not so limited. For example, the fill media layer(s) can be formed of a metal or metallic material. Furthermore, an additive processing approach may be utilized as opposed to a substrative processing approach to define the various grating material patterns. FIG. 14 is a close-up schematic cross-sectional side view illustration of a grating die 110, 114 with a metal or metallic fill media layer 118 in accordance with an embodiment. Such a configuration may operate by reflection. FIGS. 15A-15D are schematic cross-sectional side view illustrations for a sequence of forming a grating die with additive processing approach in accordance with embodiments. As shown in FIG. 15A a grating material 121, 129 can first be deposited over a carrier substrate 154, which may be a wafer such as silicon, glass, etc. The grating material layer is then patterned to form grating material patterns 120, 128, which may be in the arrangement of fins. This can be followed by deposition of a fill media layer 118, 126 to embed the grating material pattern in the fill media layer. For example, the fill media layer can be a metallic or metal layer, or other suitable optically reflective material. However, transparent dielectric materials may be selected as opposed to metals or metallic materials where transparency is needed, such as output coupler grating dies for augmented reality eye pieces. A planarization operation may then be performed. This can be followed by bonding the planarized surface to a base wafer 144, 146, such as a silicon wafer or glass wafer, removal of the carrier substrate 154, and dicing of the grating dies 110, 114.

In utilizing the various aspects of the embodiments, it would become apparent to one skilled in the art that combinations or variations of the above embodiments are possible for forming reconstituted passive optical devices. Although the embodiments have been described in language specific to structural features and/or methodological acts, it is to be understood that the appended claims are not necessarily limited to the specific features or acts described. The specific features and acts disclosed are instead to be understood as embodiments of the claims useful for illustration.

What is claimed is:

1. A passive optical device comprising:
an optically transparent substrate;
an input coupler grating die bonded to the optically transparent substrate; and
an output coupler grating die bonded to the optically transparent substrate.

2. The passive optical device of claim 1, further comprising a gap fill layer spanning between the input coupler grating die and the output coupler grating die.

3. The passive optical device of claim 2, wherein the gap fill layer spans over the input coupler grating die and the output coupler grating die.

4. The passive optical device of claim 2, wherein the input coupler grating die includes:
a first fill media layer; and
a first grating material pattern embedded in the first fill media layer.

5. The passive optical device of claim 4, wherein the input coupler grating die includes a first planar bottom surface spanning the first fill media layer and the first grating material pattern, wherein the first planar bottom surface is bonded to the optically transparent substrate.

6. The passive optical device of claim 4, wherein the first grating material pattern has a higher index of refraction than the first fill media layer.

7. The passive optical device of claim 4, wherein the output coupler grating die includes:
a second fill media layer; and
a second grating material pattern embedded in the second fill media layer.

8. The passive optical device of claim 7, wherein the output coupler grating die includes a second planar bottom surface spanning the second fill media layer and the second grating material pattern, wherein the second planar bottom surface is bonded to the optically transparent substrate.

9. The passive optical device of claim 7, wherein the first grating material pattern has a first maximum height, and the second grating material pattern has a second maximum height, wherein the first maximum height is different from the second maximum height.

10. The passive optical device of claim 4, wherein the first fill media layer comprises a metal or metallic material.

11. The passive optical device of claim 4, wherein the first fill media layer comprises multiple layers.

12. The passive optical device of claim 1, wherein the input coupler grating die and the output coupler grating die are bonded to a same side of the optically transparent substrate.

13. The passive optical device of claim 1, wherein the input coupler grating die and the output coupler grating die are bonded to opposite sides of the optically transparent substrate.

14. The passive optical device of claim 1, wherein:
the input coupler grating die and the output coupler grating die are bonded to a first side of the optically transparent substrate;
the input coupler grating die includes a dielectric first grating material pattern embedded in a metal or metallic first fill media layer; and
the output coupler grating die includes a dielectric second grating material pattern embedded in a dielectric second fill media layer.

15. The passive optical device of claim 14, further comprising an additional output coupler grating die bonded to a second side of the optically transparent substrate, the second side opposite the first side.

16. A method of assembling a passive optical device comprising:
bonding a first plurality of input coupler grating dies to an optically transparent substrate;
bonding a second plurality of second output coupler grating dies to the optically transparent substrate;
encapsulating the first plurality of input coupler grating dies and the second plurality of output coupler grating dies in one or more gap fill layers to form a reconstituted substrate; and
singulating a plurality of passive optical devices from the reconstituted substrate.

17. The method of claim 16, wherein bonding the first plurality of input coupler grating dies to the optically transparent substrate comprises fusion bonding.

18. The method of claim 16, wherein the first plurality of input coupler grating dies and the second plurality of input coupler grating dies are bonded to a same side of the optically transparent substrate.

19. The method of claim 18, wherein singulating the plurality of passive optical devices from the reconstituted substrate comprises cutting through the one or more gap fill layers and the optically transparent substrate.

20. The method of claim 16, further comprising:
forming a first donor wafer including a first array of input coupler grating die areas; and
dicing a first group of input coupler grating dies from the first donor wafer.

21. The method of claim 20, wherein forming the first donor wafer comprises:
depositing a first fill media layer on a first wafer;
forming a first pattern in the first fill media layer; and
depositing a first grating material over the first fill media layer and withing the first pattern in the first fill media layer.

22. The method of claim 21, further comprising polishing the first grating material to expose the first fill media layer, resulting in a first grating material pattern that fills the first pattern in the first fill media layer.

23. The method of claim 20, wherein forming the first donor wafer comprises:
forming a first grating material pattern on a first wafer;
depositing a first fill media layer over the first grating material pattern to embed the first grating material pattern in the first fill media layer; and
polishing the first fill media layer to expose the first grating material pattern.

24. The method of claim 16, wherein the optically transparent substrate is a glass wafer.

25. The method of claim 16, wherein the optically transparent substrate is a glass panel or polymer panel.
